(19) United States
(12) Patent Application Publication
(10) Pub. No.: US 2003/0130805 A1
(43) Pub. Date: Jul. 10, 2003

(54) Automatable measuring, cleaning and/or calibrating device for electrodes for measuring pH values or redox potentials

(76) Inventors: Detlev Wittmer, Maulbronn (DE); Berthold Gotz, Ditzingen (DE); Michael Gunzert, Talheim (DE)

Correspondence Address: JONES, TULLAR & COOPER, P.C., P.O. Box 2266 Eads Station, Arlington, VA, 22202, US

(21) Appl. No.: 10/293,935

(22) Filed: Nov. 14, 2002

(30) Foreign Application Priority Data
Nov. 14, 2001 (DE) 101 55 886.4

(51) Int. Cl. G06F 19/00; G01N 31/00

(52) U.S. Cl. 702/31

(57) ABSTRACT

The present invention relates to an automatable measuring, cleaning and/or calibrating device for electrodes for measuring pH values or redox potentials, in particular in process technology, with a measuring transducer (8) that has a programmable process computer for executing process steps, and with a control unit (10) that has a plurality of actuators (44) and/or signal inputs (42) and/or signal outputs (40).

A functional separation between the measuring transducer (8) and the control unit (10) is provided so as to be able to program the device more effectively, data being exchanged via a bidirectional communication link (13).

### DESCRIPTION

The present invention relates to an automatable measuring, cleaning and/or calibrating device for electrodes for measuring pH values or redox potentials, in particular in process technology, with a measuring transducer that has a programmable process computer for executing process steps, and with a control unit that has a plurality of actuators and/or signal inputs and/or signal outputs.

The present invention further relates to a method for operating an automatable measuring, cleaning and/or calibrating device of the aforementioned type.

Devices of the aforementioned type are known and are used for determining pH values or redox potentials of a test medium in the processing industry, in effluent treatment, but also in the food and drugs industries.

Periodic cleaning and calibrating of the device are provided in order to increase the endurance of the electrodes used for measurement, and to ensure the measuring accuracy of the device. The processes of cleaning and calibrating are automated and are carried out by first using a cleaning solution to clean the electrode in the absence of the test medium, in order to remove residues of the test medium sticking to the electrode. After the cleaning, a calibrating solution with a precisely defined pH value is supplied to the electrode, and this permits a calibrating operation of the measuring device.

It is the object of the present invention to improve a measuring, cleaning and/or calibrating device of the aforementioned type to the effect that processes can be more simply automated, and program runs on which the process steps are based can be more easily programmed.

Starting from a measuring, cleaning and/or calibrating device of the type mentioned at the beginning, this object is achieved according to the invention in that process steps that include triggering the actuators or the signal outputs of the control unit and/or detecting signals at the signal inputs of the control unit can be executed only by the control unit, and that appropriate instructions for executing such process steps can be transmitted from the measuring transducer to the control unit.

It is possible in this way to coordinate very complex process cycles such as, for example, cooperation between a plurality of actuators as well as, if appropriate, detecting corresponding input signals at the signal inputs of the control units and any desired outputting of signals via the signal outputs of the control unit, and to render these transparent for the measuring transducer and/or its process computer. This mechanism permits comprehensive control and automatic control operations to be represented in a program of the process computer by, for example, a single instruction. Program runs can thereby be programmed more simply.

In the case of conventional measuring, cleaning and/or calibrating devices whose components are controlled with the aid of memory-programmable controllers for executing process steps, the triggering of actuators or signal outputs, and/or the detection of input signals even of a plurality of components are carried out centrally by the memory-programmable controller. Particularly in the case of programming complex program cycles, this results in the problem of always having to ensure the correct programming association between a function required in the process cycle, of the measuring, cleaning and/or calibrating device and, for example, triggering the corresponding actuator.

What is completely novel in the case of measuring, cleaning and/or calibrating devices of the type mentioned at the beginning is the implementation of a principle, known from object-oriented programming, called “information hiding”. Very generally, this term denotes measures aimed at using operating variables of closed functional units only within the respective functional units to which they are assigned. Particularly in the case of very complex systems, this prevents the inadvertent use and/or modification, within a first functional unit, of operating variables that are intended exclusively for processing process cycles within a second functional unit.

Calibration and the device required therefor are not mandatory for systems with low requirements in terms of measuring accuracy. However, such measuring and cleaning devices also profit from the simpler automatability and programmability.

One embodiment of the measuring, cleaning and/or calibrating device according to the invention is defined in that a bidirectional communication link, preferably a type RS 485 interface, is provided for transmitting the instructions between the measuring transducer and the control unit.

A further embodiment of the measuring, cleaning and/or calibrating device according to the invention provides that a master-slave protocol is provided for communication via the communication link, the measuring transducer constituting the master, and the control unit the slave. This principle ensures that the programming outlay in the control unit for operating the communication with the measuring transducer is minimal. In accordance with the proposed master-slave protocol, the control unit waits until it receives an instruction from the measuring transducer, then, if appropriate, processes a prescribed process cycle as a function of the received instruction, and sends back a status report to the measuring transducer.

Given an appropriate refinement of the master-slave protocol and the bidirectional communication link, it is possible to connect a measuring transducer to a plurality of control units that each control one electrode fitting, for example. It is also possible for one measuring transducer to have a plurality of measuring channels.

A particularly advantageous embodiment of the invention provides that there is an interface in the measuring transducer for connecting a personal computer, via which interface the process computer can be programmed with the aid of the personal computer, and/or there is a field-bus, professional-bus, HART, or FOUNDATION field-bus interface. This type of programming of the process computer is particularly advantageous, since the process cycles, which are usually complex, need not be programmed in situ, that is to say directly at the measuring, cleaning and/or calibrating device. A further advantage consists in that, for example, the provision of appropriate software tools for the personal computer renders possible graphics programming of the process cycles, which has proved to be very expedient with other systems, as well.

Moreover, it is possible to design the proposed interface for connecting a personal computer in such a way that it is also possible to connect a semiconductor memory, in particular a EEPROM/flash memory, such that process cycles programmed into the semiconductor memory can be read out by the measuring transducers, and vice versa. It is also possible as a result to transfer process cycles to a plurality of measuring, cleaning and calibrating devices very simply. Measurement and calibration data can also be communicated and secured in this way.

In a further embodiment of the invention, it is proposed to provide a separate interface in the measuring transducer for connecting the semiconductor memory.

The EEPROM/flash memories can be programmed by a programming device with the process cycles to be executed, and thereafter the EEPROM/flash memories programmed in this way can be connected to the appropriate interface of the measuring, cleaning and/or calibrating device such that the information can be read out by the measuring transducer via the process cycles programmed in the EEPROM/flash memories.

As a further achievement of the object of the present invention, starting from the method, named at the beginning, for operating an automatable measuring, cleaning and/or calibrating device, it is proposed that process steps that include triggering the actuators and/or the signal outputs of the control unit and/or detecting signals at the signal inputs of the control unit can be executed only by the control unit, and that appropriate instructions for executing such process steps can be transmitted from the measuring transducer to the control unit.

A security concept implemented in the control unit provides that the signal outputs assume a defined state if the electrical power supply fails; this makes it possible to put actuators, pneumatically driven elements, and the like into a secure shutoff state, such as a servicing position.

The security concept can be expanded to take the following cases of error or failure into account: a failure of compressed air or water, and an interruption in communications. In these failures as well, a defined shutoff state is expedient.

As soon as the failure has been corrected, a re-starting or re-booting program will initiate the proper resumption of operation.

One embodiment of the method according to the invention is defined in that the instructions are transmitted via a bidirectional communication link, and that the communication proceeds according to the master slave principle, the measuring transducer constituting the master, and the control unit the slave.

A further embodiment of the method of the invention is characterized in that the control unit, after being turned on, enters a service state, in which it waits for a first instruction from the measuring transducer; that after receiving the first instruction from the measuring transducer, the control unit executes the first instruction and thereafter sends a status report to the measuring transducer; and that after sending the status report, the control unit enters a waiting state, in which it waits for further instructions from the measuring transducer.

A further embodiment of the method according to the invention is defined in that after being switched on, the control unit goes into a service state in which it awaits a first instruction from the measuring transducer; that after receiving the first instruction from the measuring transducer the control unit executes the first instruction and thereafter sends a status report to the measuring transducer; and that after sending the status report the control unit goes into a waiting state in which it awaits further instructions from the measuring transducer.

Another embodiment of the method according to the invention provides that after being switched on, the measuring transducer runs through an initialization phase; that after the initialization phase the measuring transducer sends a first instruction to the control unit, in order, for example, to determine the hardware and software versions of the control unit; that after receiving an appropriate status report from the control unit the measuring transducer sends an instruction dependent on a process cycle to the control unit; and that after receiving an appropriate status report from the control unit the measuring transducer executes further process steps.

Further features, possible applications and advantages emerge from the following description of exemplary embodiments of the invention, which are illustrated in the figures of the drawing. Here, all features described or illustrated either alone or in any desired combination, the subject matter of the invention independently of their summary in the patent claims or their claims dependencies, as well as independently of their formulation or representation in the description and/or in the drawing.

In the drawing:

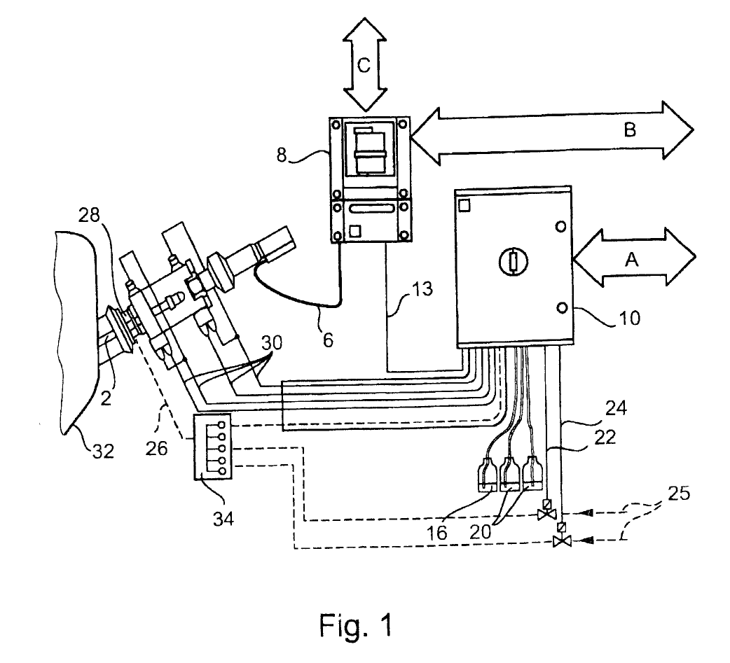

FIG. 1 shows a schematic view of an automatable measuring, cleaning and calibrating device according to the invention;

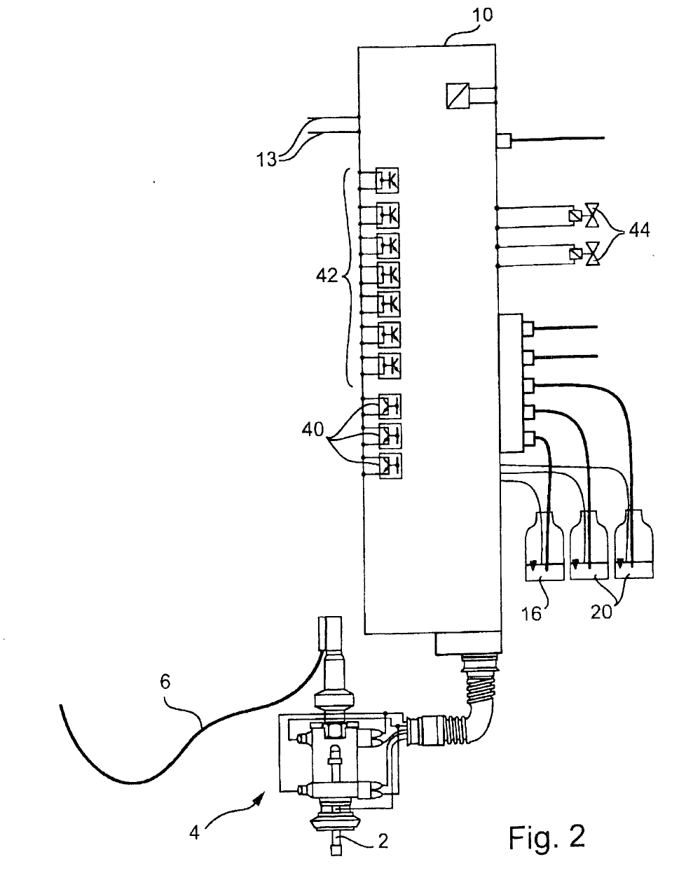

FIG. 2 shows a schematic view of the control unit of FIG. 1, in an enlarged representation,

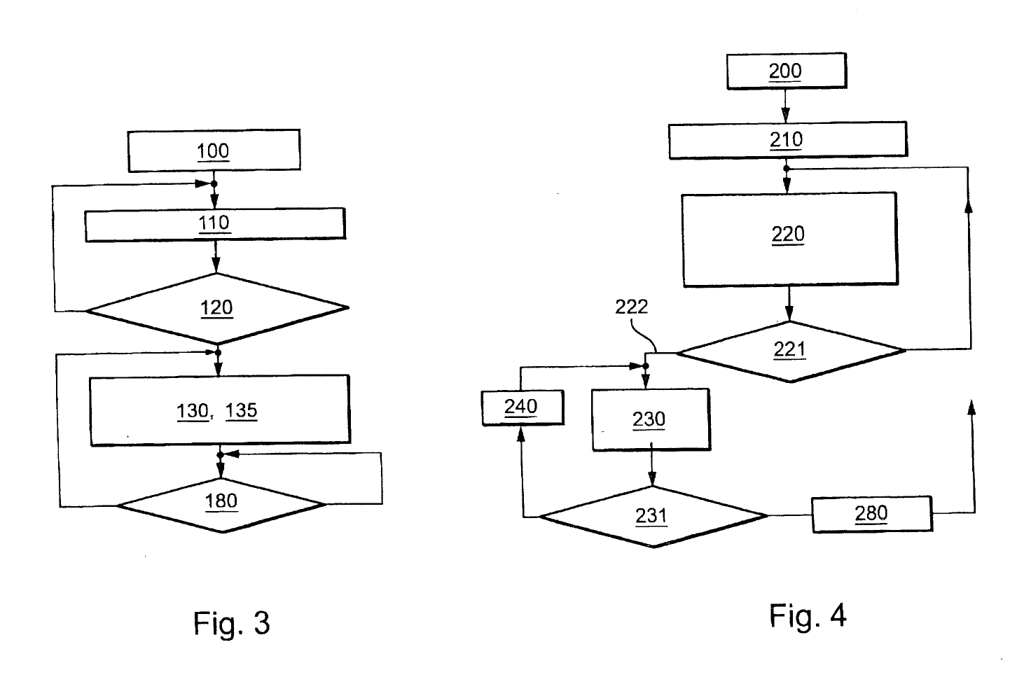

FIG. 3 shows a process flowchart that has the steps of the method according to the invention that are intended to be executed in the control unit of FIG. 2; and

FIG. 4 shows a program flowchart that has the steps of the method according to the invention that are to be executed in the measuring transducer of FIG. 1.

FIG. 1 schematically shows an automatable measuring, cleaning and calibrating device for electrodes for measuring pH values or redox potentials.

The electrode 2 is mounted in an electrode fitting 4 and connected to a measuring transducer 8 via an electrode cable 6. The measuring transducer 8 is connected to a control unit 10 via a communication link 13.

The control unit 10 has connections for pneumatic control lines 30 that lead to the electrode fitting 4. Moreover, storage vessels for calibration solutions 20 and washing liquid 16 are connected to the control unit 10 and are pumped into the rinsing chamber 28 of the fitting by means of a pump.

The actuators 22 and 24 are likewise connected to the control unit 10 and act on a feed 25 for superheated steam or other cleaning agents.

A rinsing block arrangement 34, likewise illustrated in FIG. 1, has a plurality of valves and serves the purpose of selectively feeding water, compressed air, or superheated steam into the rinsing chamber 28, which is connected to the rinsing block arrangement 34 via a delivery line 26.

The control unit 10 has an interface A for report and control signals. The measuring transducer 8 has a user interface B and an interface C to a personal computer, hereinafter called a PC interface for short.

FIG. 2 shows an enlarged view of the control unit 10 of FIG. 1. The control unit 10 has a plurality of signal inputs 42 and a plurality of signal outputs 40. Further actuators 44 are also illustrated.

The mode of operation of the automatable measuring, cleaning and calibrating device depicted in FIGS. 1 and 2 is explained in more detail below.

The measuring transducer 8 has a process computer for executing process steps. Such process steps consist, for example, of moving the electrode 2 inside the electrode fitting 4 between a first position inside a process vessel 32 and a second position in which the electrode 2 can be cleaned inside the rinsing chamber 28. Pneumatic actuators located in the electrode 34 can be triggered as appropriate for this purpose by the control unit 10, via the pneumatic control lines.

Further process steps consist of delivering cleaning liquid 16 or calibration solutions 20 from the storage vessels connected to the control unit 10, of triggering the rinsing block arrangement 34, and of detecting measured values or the output of signals.

There are also process steps which require the actuators connected to the control unit 10 to be triggered in a complex time sequence.

The process steps that make use of components connected directly to the measuring transducer 8 are executed by the process computer of the measuring transducer 8. An example of this is the detection of measured values that are supplied directly to the measuring transducer 8 from the electrode 2 via the electrode cable 6.

A further example includes all those processes that are required for interaction with an operator via the user interface B. These include the manual selection of operating modes of the device, the programming of the process computer, but also the display of process data.

The PC interface C can also be used to program the process computer. It is particularly advantageous in this case to be able to program process cycles graphically with the aid of software tools.

It is possible, furthermore, to connect an EEPROM/flash memory to the interface C, such that process cycles programmed into the EEPROM/flash memory can be read out by the measuring transducer 8. These process cycles can then also be executed by the process computer.

A separate interface for EEPROM/flash memories can likewise be provided in addition to the PC interface C.

There are process steps that include triggering the actuators 44, 22, 24 and/or the signal outputs 40 of the control unit 10, and/or detecting signals at the signal inputs 42 of the control unit 10, or triggering the pneumatic control lines 30 as well as the actuators of the storage vessels 16 and 20. These process steps are characterized in that they are carried out by using the components of the control device that are connected to the control unit 10. Such process steps are executed by the control unit alone. The operating variables or information required to execute these process steps are stored only in the control unit 10 and are therefore not included in the program of the process computer of the measuring transducer 8.

To execute such a process step, the measuring transducer 8 sends an appropriate instruction to the control unit 10 via the bidirectional communication link 13. After receipt of this instruction, the control unit 10 executes the corresponding process step and sends a status report back to the measuring transducer 8.

In order to implement this functional separation between the measuring transducer 8 and control unit 10, the process computer of the measuring transducer 8 need only know the instructions that can be executed by the control unit 10. Examples of such instructions are an instruction to interrogate the status of the control unit 10, an instruction to move the electrode 2 into measuring position, an instruction to move the electrode 2 into a waiting position, instructions to deliver cleaning and/or calibration solutions, and the like.

This functional separation is known from object-oriented programming by the term “information hiding”—see “On the Criteria to be used in Decomposing Systems into Molecules” by David Parnas, 1972—and can also be applied very advantageously in the case of the present device. The aim of information hiding is to use, and make available for use, operating variables of close functional units only inside the respective functional unit, such as the control unit 10, in order to preclude inadvertent variation inside another function unit for example in the measuring transducer 8.

The flexibility and programmability of the device is improved by moving the process steps under discussion from the process computer of the measuring transducer 8 into the control unit 10. Programming process cycles for the purpose of automation can be kept substantially simpler by using the instructions for triggering the control unit 10, since all the operating variables of the control unit 10 that are involved, for example, in the time control of actuators of the control unit 10 are not stored in the process computer of the measuring transducer 8. These operating variables are stored only in the control unit 10 and are also processed only there. This lightens the burden on the process computer of the measuring transducer 8. It also reduces the risk of programming errors and improves the readability and clarity of corresponding programs.

An exemplary communication between the measuring transducer 8 and the control unit 10 is explained below with the aid of the program flowcharts, illustrated in FIGS. 3 and 4.

First, the implementation of the method according to the invention in the control unit 10 of the automatable measuring, cleaning and calibrating device in FIG. 3 will be considered.

After the control device 10 has been switched on at 100, the control unit 10 is in the service state 110. The control unit 10 then awaits an instruction from the measuring transducer 8, which is represented by the interrogation 120. As long as no instruction is received from the measuring transducer 8, the control unit 10 remains in the service state 110.

After the reception of an instruction, the latter is executed in the state 130 and, directly following the execution 130 of the instruction, a corresponding status report 135 is output to the measuring transducer 8 via the bidirectional communication link 30. After the output of the status report 135, the control unit 10 remains in a waiting state 180 until an instruction is once again received from the measuring transducer 8. The reception of a new instruction is continuously interrogated in the waiting state 180.

As illustrated in FIG. 4, the measuring transducer 8 runs through an initialization phase 210 after being switched on at 200. Upon termination of the initialization phase 210, the measuring transducer 8 sends a first instruction 220 to the control unit 10 via the bidirectional communication link 13. This first instruction 220 is used, for example, for interrogation about the hardware and software versions of the control unit 10.

Afterward, the measuring transducer 8 waits in the state 221 for a status report from the control unit 10. If, for example, no status report has been received in the measuring transducer 8 within a prescribed waiting time, the measuring transducer 8 again sends the first instruction 220 to the control unit.

As soon as the measuring transducer 8 has received the status report, in the state 230 it can send instructions or status requests as well to the control unit 10. The further processing 240 is not performed until after reception of an appropriate status report 231. Subsequent thereto, an instruction or a status request can again be sent by the measuring transducer 8 to the control unit 10.

If no status report 231 is received within a prescribed waiting time, a routine 280 for error treatment is called up, and after it has been executed the measuring transducer 8 can, for example, once again be put into the initialization phase 210.

In accordance with FIGS. 3, 4, the communication between the measuring transducer 8 and the control unit 10 via the bidirectional communication link 13 proceeds according to the master-slave protocol, the measuring transducer 8 constituting the master, and the control unit 10 the slave.

In the case of a communication failure, an error is stored in the measuring transducer. The control unit 10 is reset, and the actuators 44 assume a starting position.

In the event of a compressed air failure, the actuators 44 are put into a defined servicing position with the aid of the residual air pressure, and an error report is transmitted to the measuring transducer 8.

It is also possible for a plurality of control units 10 to be operated jointly with the aid of the measuring transducer 8. For this purpose, the master-slave protocol must be designed such that the measuring transducer 8 can respond to precisely one of the plurality of control units 10, for example, via an address included in the instructions. It is possible in this way to use the measuring transducer 8 to trigger a plurality of electrode fittings by means of a plurality of control units 10. The measuring transducer 8 can have a plurality of measuring channels.

1. An automatable measuring, cleaning and/or calibrating device for electrodes for measuring pH values or redox potentials, in particular in process technology, with a measuring transducer (8) that has a programmable process computer for executing process steps, and with a control unit (10) that has a plurality of actuators (44) and/or signal inputs (42) and/or signal outputs (40), characterized in that process steps that include triggering the actuators (44) and/or the signal outputs (40) of the control unit (10) and/or detecting signals at the signal inputs (42) of the control unit (10) can be executed only by the control unit (10); and that appropriate instructions for executing such process steps can be transmitted from the measuring transducer (8) to the control unit (10).

2. The device as claimed in claim 1, characterized in that a bidirectional communication link (13), preferably a type RS 485 interface, is provided for transmitting the instructions.

3. The device as claimed in claim 1 or 2, characterized in that a master-slave protocol is provided for communication via the communication link (13), the measuring transducer (8) constituting the master, and the control unit (10) the slave.

4. The device as claimed in one of the preceding claims, characterized in that in the measuring transducer (8), an interface (C) for connecting a personal computer, via which the process computer can be programmed with the aid of the personal computer, and/or a field-bus, professional-bus, HART, or FOUNDATION field-bus interface, is provided.

5. The device as claimed in claim 4, characterized in that it is also possible to connect to the interface (C) a semiconductor memory, in particular an EEPROM/flash memory; and that process cycles programmed into the semiconductor memory can be read out and/or programmed in by the measuring transducer (8).

6. The device as claimed in claim 5, characterized in that a separate interface for connecting the semiconductor memory is provided in the measuring transducer (8).

7. The device as claimed in one of the preceding claims, characterized in that a plurality of control units (10) are provided; and that the measuring transducer (8) has at least one measuring channel.

8. A method for operating an automatable measuring, cleaning and/or calibrating device for electrodes for measuring pH values or redox potentials, in particular in process technology, with a measuring transducer (8) that has a programmable process computer for executing process steps, and with a control unit (10) that has a plurality of actuators (44) and/or signal inputs (42) and/or signal outputs (40), characterized in that process steps that include triggering the actuators (44) and/or the signal outputs (40) of the control unit (10) and/or detecting signals at the signal inputs (42) of the control unit (10) can be executed only by the control unit (10); and that appropriate instructions for executing such process steps can be transmitted from the measuring transducer (8) to the control unit (10).

9. The method as claimed in claim 8, characterized in that the instructions are transmitted via a bidirectional communication link (13); and that the communication proceeds according to the master slave principle, the measuring transducer (8) constituting the master, and the control unit (10) the slave.

10. The method as claimed in claim 9, characterized in that after being switched on (100), the control unit (10) goes into a service state (110) in which it awaits a first instruction from the measuring transducer (8); that after receiving the first instruction from the measuring transducer (8) the control unit (10) executes the first instruction (130) and thereafter sends a status report (135) to the measuring transducer (8); and that after sending the status report (135) the control unit (10) goes into a waiting state (180) in which it awaits further instructions from the measuring transducer (8).

11. The method as claimed in claim 10, characterized in that after being switched on (200), the measuring transducer (8) runs through an initialization phase (210); that after the initialization phase (210) the measuring transducer (8) sends a first instruction (220) to the control unit (10); that after receiving (222) an appropriate status report from the control unit (10) the measuring transducer (8) sends an instruction (230) dependent on a process cycle to the control unit (10); and that after receiving an appropriate status report (231) from the control unit (10) the measuring transducer (8) executes further process steps (240).

12. The method as claimed in one of claims 8-11, characterized in that if there is a power failure and/or a or the communications link (13) fails, the control unit (10) puts the actuators (44) and/or the signal outputs (40) in a defined state.
